(19) United States
(12) Patent Application Publication
(10) Pub. No.: US 2021/0011922 A1
(43) Pub. Date: Jan. 14, 2021

(54) SYSTEM AND METHOD THEREOF FOR GENERATING BELIEVABILITY SCORES OF STATEMENTS IN ELECTRONIC DISCUSSIONS

(71) Applicant: Ment Software Ltd., Tel Aviv (IL)

(72) Inventor: Etam BENGER, Tel Aviv (IL)

(73) Assignee: Ment Software Ltd., Tel Aviv (IL)

(21) Appl. No.: 16/923,887

(22) Filed: Jul. 8, 2020

Related U.S. Application Data
(60) Provisional application No. 62/871,364, filed on Jul. 8, 2019.

(51) Int. Cl. G06F 16/2457; G06F 16/9032; G06F 16/908; H04L 12/58

(52) U.S. Cl. CPC G06F 16/24578; H04L 51/16; G06F 16/908; G06F 16/90332

(57) ABSTRACT

A system and method for generating believability scores of statements in electronic discussions. A method includes receiving a first statement, wherein the first statement is at least a portion of an electronic discussion; receiving a first reference input for the first statement, wherein the first reference input is one of a supporting reference input for the first statement and an opposing reference input for the first statement; extracting, from a log file, a first metadata of a first user associated with the first reference input; analyzing the received first reference input using the extracted first metadata and at least a first predetermined rule; and generating, based on the analysis, a first believability score of the first statement.

### CROSS-REFERENCE TO RELATED APPLICATIONS

This application claims the benefit of U.S. Provisional Application No. 62/871,364 filed on Jul. 8, 2019, the contents of which are hereby incorporated by reference.

### TECHNICAL FIELD

The disclosure generally relates to analysis of electronic discussions and, more specifically, to systems and methods for generating believability scores of statements in electronic discussions.

### BACKGROUND

As technology advances, the various innovations allow users to share content rapidly and easily over the internet. Therefore, enormous amounts of data are generated, shared, and stored every day.

In large, medium, and even small organizations, quantities of data are rapidly developed such that data becomes difficult to track. Specifically, when a discussion starts in an electronic platform, tracking the thread as it develops is a complex task.

Another challenge organizations face is the identification of believable statements, or answers, in the electronic discussion. That is, answers on which one can rely to be correct and accurate. By identifying an answer as a believable answer, the electronic discussion becomes a significant tool for decision-making.

Presently-available technologies provide certain, limited solutions for collecting and analyzing data. Certain solutions for the identification of high-quality discussion content include user rankings, describing a particular user or speaker as a subject matter expert or high-quality contributor, as are implemented in business review platforms such as Yelp® and Google® reviews. Further solutions include community content voting tools, which may allow community members to “like” or “dislike” particular comments or reviews, as are implemented with respect to customer question and answer discussions on the Amazon® shopping platform. In addition, solutions to analyzing discussion data may include automated fact-checking tools, providing for automatic detection of false or misleading information and presentation of relevant warnings.

However, such solutions do not provide an efficient method for overcoming the challenges noted above. It would therefore be advantageous to provide a solution that would overcome these challenges.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating believability scores of statements in electronic discussions. The method comprises: receiving a first statement, wherein the first statement is at least a portion of an electronic discussion; receiving a first reference input for the first statement, wherein the first reference input is one of a supporting reference input for the first statement and an opposing reference input for the first statement; extracting, from a log file, a first metadata of a first user associated with the first reference input; analyzing the received first reference input using the extracted first metadata and at least a first predetermined rule; and generating, based on the analysis, a first believability score of the first statement.

Certain embodiments disclosed herein also include a non-transitory computer readable medium having stored thereon instructions for causing a processing circuitry to execute a process, the process comprising: receiving a first statement, wherein the first statement is at least a portion of an electronic discussion; receiving a first reference input for the first statement, wherein the first reference input is one of a supporting reference input for the first statement and an opposing reference input for the first statement; extracting, from a log file, a first metadata of a first user associated with the first reference input; analyzing the received first reference input using the extracted first metadata and at least a first predetermined rule; and generating, based on the analysis, a first believability score of the first statement.

In addition, certain embodiments disclosed herein include a system for generating believability scores of statements in electronic discussions, comprising: a processing circuitry; and a memory, the memory containing instructions that, when executed by the processing circuitry, configure the system to: receive a first statement, wherein the first statement is at least a portion of an electronic discussion; receive a first reference input for the first statement, wherein the first reference input is one of a supporting reference input for the first statement and an opposing reference input for the first statement; extract, from a log file, a first metadata of a first user associated with the first reference input; analyze the received first reference input using the extracted first metadata and at least a first predetermined rule; and generate, based on the analysis, a first believability score of the first statement.

### BRIEF DESCRIPTION OF THE DRAWINGS

The foregoing and other objects, features and advantages of the disclosure will be apparent from the following detailed description taken in conjunction with the accompanying drawings.

FIG. 1 is a network diagram utilized to describe the various disclosed embodiments.

FIG. 2 is a schematic diagram of the computing device according to an embodiment.

FIG. 3 is a flowchart illustrating a method for generating believability scores of statements of electronic discussions according to an embodiment.

FIG. 4 is a flowchart illustrating a method for adjusting a believability score of a statement according to an embodiment.

FIG. 5 is a schematic diagram illustrating the influence of reference inputs on a believability score of statements according to an embodiment

FIG. 6 is a flowchart describing a method for assessing claim believability based on sub-claim believability, according to an embodiment.

### DETAILED DESCRIPTION

It is important to note that the embodiments disclosed by the disclosure are only examples of the many advantageous uses of the innovative teachings herein. Moreover, some statements may apply to some inventive features but not to others. In general, unless otherwise indicated, singular elements may be in plural and vice versa with no loss of generality. In the drawings, like numerals refer to like parts through several views.

According to some example embodiments, upon receiving a statement of an electronic discussion, reference inputs relating to the statement are received. Each such input is a supporting reference input or an opposing reference input for the statement. Then, a first metadata of a first user who inputted the first reference input is extracted. The first metadata may include a user believability score, a user topic-based believability score, and a relationship between the first user and at least a second user who inputted at least a second reference input. The reference inputs are analyzed based on the extracted metadata and a predetermined rule. Thus, a believability score for the statement is generated. A second believability score of the one or more reference inputs, of at least a second statement, or both, may be extracted and analyzed with the first believability score for adjusting the first believability score, the second believability score, or both.

Electronic discussion is a thread that usually includes statements and reference inputs. Statements may be, for example, answers to a question that was previously raised in the electronic discussion. Reference input may be a claim inputted by a user with respect to a statement, a sub-claim inputted with respect to a previous claim, and the like. As further described hereinbelow, the reference inputs, i.e., claims and sub-claims, may be of two kinds, a supportive reference input or an opposing reference input. For instance, reference inputs B, C, and D support statement A, while reference input E opposes statement A. As another non-limiting example, reference inputs B, C, and D support statement A, while reference inputs D-1, D-2, D-3, and D-4 oppose reference input D.

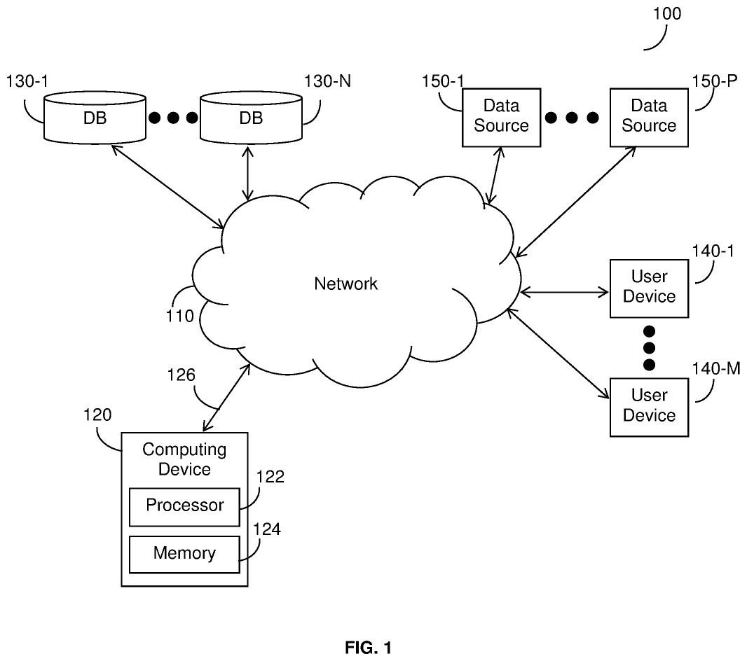

FIG. 1 shows an example network diagram 100 utilized to describe the various disclosed embodiments. In the example network diagram 100, a computing device 120, a plurality of databases 130-1 through 130-N (hereinafter referred to individually as a “database” 130 and collectively as “databases” 130, merely for simplicity purposes), and a plurality of user devices 140-1 through 140-M, are communicatively connected via a network 110.

In an embodiment, a plurality of data sources 150-1 through 150-P (hereinafter referred to individually as a “data source” 150 and collectively as “data sources” 150, merely for simplicity purposes) are communicatively connected via the network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The computing device 120 is communicatively connected, to the network 110. In an embodiment, the computing device 120 is a combination of computer hardware and computer software components configured to execute predetermined computing tasks. The computing device 120 may be a physical machine, or a virtual machine. The computing device 120 may be any virtual entity executed in a cloud environment.

The database 130 may be configured to store, for example, data, metadata, or both, that is associated with one or more users. For example, relevant data or metadata may include, without limitation, a user's general and predetermined believability score, a user's knowledge level in one or more topics, a relationship between users in electronic discussions, and so on, as further described hereinbelow. In an embodiment, the database 130 may further include one or more log files that contain metadata of one or more electronic discussions. In an embodiment, the database 130 further includes a predetermined rule, such as a mathematical rule, that is utilized by the computing device 120 as further described hereinbelow.

The user device 140 may be a personal computer (PC), a laptop, a smartphone, a tablet, a wearable device, or another, like, device that is designed to send to the user device 140 and receive data such as, statements, such as answers to questions, or reference inputs, such as claims and sub-claims, as further described hereinbelow.

The data source 150 may be, for example, a website, an application, and the like, in which electronic discussions occur. In an embodiment, the computing device 120 is configured to collect or receive data, metadata, or both of electronic discussions that occur in a data source, such as the data source 150, and apply thereto the disclosed method that is described hereinbelow.

In an embodiment, the computing device 120 is configured to receive a first statement. The first statement may be, for example, a sentence, an answer, an image, a video, a link to a website, and the like, that is a portion of an electronic discussion. The electronic discussion may be a thread that includes statements and one or more inputs that refer thereto as further discussed hereinabove and below. The first statement may include, for example, an answer stating that “Yes, oil prices will rise in the US next year.” It should be noted that the statement is inputted to the electronic discussion by a user device, such as the user device 140, that is associated with a user.

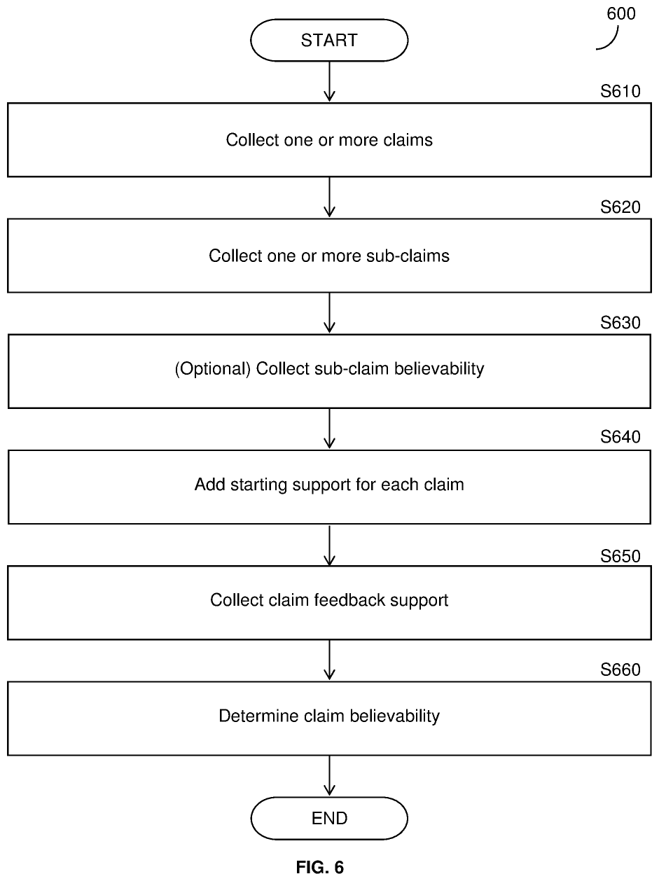

In an embodiment, the computing device 120 is configured to receive a first reference input for a first statement. The first reference input is a supporting reference input for the first statement or an opposing reference input for the first statement. The reference input may be, for example, a supporting claim with respect to the first statement. A supporting reference input may be identified by, for example, an up-vote relating to the first statement. The reference input may be, for example, an opposing claim with respect to the first statement. An opposing reference input may be identified by, for example, a down-vote relating to the first statement. As a non-limiting example, statement “A” states that “air pollution will rise all across Brazil in 2025.” According to the same example, five reference inputs support the statement “A,” i.e., five users tapped a “like” key, or an “up-vote” key, and forty other reference inputs oppose the statement “A,” i.e., forty users tapped a “dislike” button, or an “down-vote” button. In an embodiment, the first reference input may include text, links, image, video, a presentation, and the like. The application of reference believability scoring, including scoring incorporating community voting, as described with respect to up-and-down-voting referenced above, is described in greater detail with respect to FIG. 6, below.

In an embodiment, the computing device 120 is further configured to extract a first metadata of a first user who inputted the first reference input. The first metadata may be, as examples and without limitation, a user believability score, a user topic-based believability score, or a relationship between the first user and a second user who inputted a second reference input of the electronic discussion.

A user believability score represents a predetermined confidence level of a user's input. For example, a first user may have a relatively high user believability score and, therefore, may be very reliable, such as may be the case for a user who provides answers that most people agree with, and a second user may have a relatively low user believability score, indicating that the user provided inputs, such as answers, that were not accurate, were not true, most people did not agree with, and the like.

A user's topic-based believability score relates to the user's specialty level in specific topics. For example, a first user may have relatively high topic-based believability scores in economics and politics and relatively low topic-based believability scores in marketing and science. The relationship between a first user and a second user, who inputted a second reference input of the electronic discussion, may indicate that the first user is the boss of the second user, that the second user always agrees with statements inputted by the first user, and the like.

It should be noted that the first metadata may be extracted from a log file. The log file may be stored in a database, such as the database 130. In an embodiment, the log file may be extracted from a data source, such as the data source 150. In a further embodiment, the first metadata may be extracted from other sources without departing from the scope of the disclosed embodiments.

In an embodiment, the computing device 120 is configured to analyze the received reference input using the extracted first metadata and a first predetermined rule. The first predetermined rule may be a mathematical rule, such as a formula, that when analyzed together with the reference input and the extracted first metadata, facilitates the computing device 120 to determine a believability score of the first statement.

For example, a first statement which states that “oil prices will rise in 2020” is received, and thirty-four supportive reference inputs and two opposing reference are received with respect to the statement. According to the same example, the believability scores of the thirty-four users who inputted the thirty-four supportive reference inputs are relatively high, such as above eight-tenths out of one. According to the same example, thirty out of the thirty-four users who inputted the supportive reference inputs are specializing in economics. According to the same example, one supporting reference input was inputted by a first user who is the boss of twenty-three of thirty-four users that also inputted supporting reference inputs. According to the same example, one supporting reference input was inputted by a second user who is the chief executive officer (CEO) of the company. According to the same example, the believability scores of the two users who inputted the two opposing reference inputs are relatively low, such as four-tenths and five-tenths out of one, respectively.

Further, the computing device 120 may analyze the amount of received reference inputs and the extracted metadata using a predetermined rule, such as mathematic formula, that computes all of the metadata, i.e., all metadata items that are discussed herein. The analysis may be achieved using one or more machine learning algorithms.

It should be noted that the amount of influence of a reference input, such a claim, on the believability of a statement, such as an answer, depends on the reference input's own believability score. The believability of a reference input, such as a claim, is defined as the probability of a reference input, such as a claim, being correct given all the observed relations in the discussion, i.e. the posterior marginal probability of a reference input, such as a claim, node. For example, a less believable opposing reference input will have lesser weight in the total opposition to a statement.

A reference input's believability score, in turn, depends on the believability of all the other reference inputs which are related to it by support or opposition. It should be further noted that a reference input's believability score depends also on its parent reference input believability, such as a parent-claim believability score. For example, a sub-reference input, such as a sub-claim, that opposes a highly believable reference input, such as a claim, will be accredited with a lower believability score than a sub-reference input opposing a different, less believable claim, regardless of the decrease in believability that both parent-claims will suffer. That is, the belief propagation is assumed to propagate in all directions simultaneously.

In an embodiment, the computing device 120 is configured to generate, based on the analysis, a first believability score of the first statement. The first believability score may be a numeric value, for example, between zero and one, such as nine-tenths. The believability score that is associated with each of the statements of an electronic discussion indicates which statement is more believable, correct, accurate, and the like and, therefore, scored higher. It should be noted that the same applies for scoring reference inputs, such as claims and sub-claims, that constitute the reasoning behind the believability of statements, such as answers.

In an embodiment, the computing device 120 is further configured to generate an initial believability score of the first statement. The initial believability score reflects the believability of the first statement based on partial information. For example, the initial believability score may be generated based only on a believability score of the user who inputted the statement. The initial believability score may be used by the computing device 120 to generate the first believability score of the first statement.

In an embodiment, the first believability score of the first statement is adjusted based on a second believability score of the first reference input, a second statement of the electronic discussion, or both. The adjustment is achieved by extracting the second believability score of at least one of: the first reference input and a second statement of the electronic discussion. The second believability score may be extracted from a log file, database, data source, web source, and the like.

Then, the computing device 120 may be configured to analyze the first believability score and the second believability score with a second predetermined rule. The second predetermined rule may be a mathematic rule, such as a formula, that calculates the first believability score and the second believability score. Based on the analysis, the computing device 120 may be configured to adjust at least one of the first believability score and the second believability score. That is, as the electronic discussion develops, new reference inputs and new statements are received at the computing device 120, some of which have direct relation to the first statement, and some of which may have indirect relation to the first statement. These new inputs and new statements, as well as their sub-reference inputs and sub-statements, may have influence on the first believability score. Also, a second believability score of a second statement, or of a reference input, may be adjusted as well, based on the new reference inputs and new statements. It should be noted that the analysis may be achieved using one or more machine learning algorithms.

In an embodiment, the computing device 120 may be further configured to determine users' believability scores. A believable user is expected to provide better statements and better reference inputs, so there should be a correlation between a user's believability score and the scores given to their statements and references inputs.

According to another embodiment, the computing device 120 is configured to optimize the display of statements, reference inputs, or both, having a higher believability score than other statements, reference inputs, or both. Optimizing the display may include, for example, positioning the statements, reference inputs, or both, having the higher scores at the top of a web page, marking them with a distinguishing color, displaying their believability scores, generating a split display including only statements, reference inputs, or both having believability scores which are above a predetermined threshold, and the like.

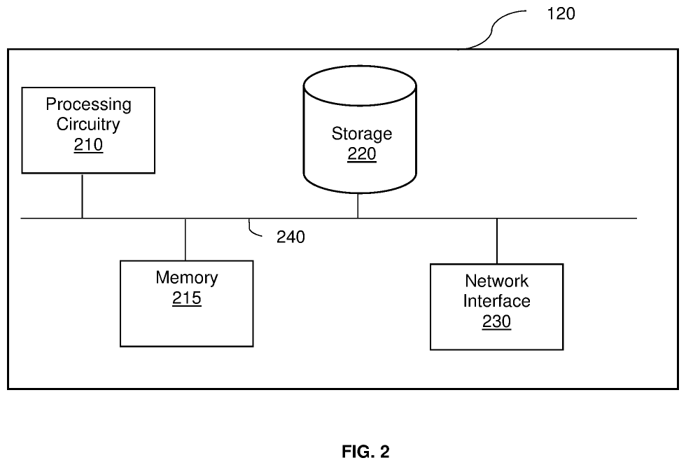

FIG. 2 is an example schematic diagram of the computing device 120, according to an embodiment. The computing device 120 includes a processing circuitry 210 coupled to a memory 215, a storage 220, and a network interface 230. In an embodiment, the components of the computing device 120 may be communicatively connected via a bus 240.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile, such as random access memory (RAM) and the like, non-volatile, such as read-only memory (ROM), flash memory, and the like, or a combination thereof. In one configuration, computer-readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code, such as in source code format, binary code format, executable code format, or any other suitable format of code. The instructions, when executed by the one or more processing circuitries 210, cause the processing circuitry 210 to perform the various processes described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the computing device 120 to communicate with databases, data sources, and other electronic devices for the purpose of, for example, retrieving data, storing data, and the like.

It should be understood that the embodiments described herein are not limited to the specific architecture illustrated in FIG. 2, and that other architectures may be equally used without departing from the scope of the disclosed embodiments.

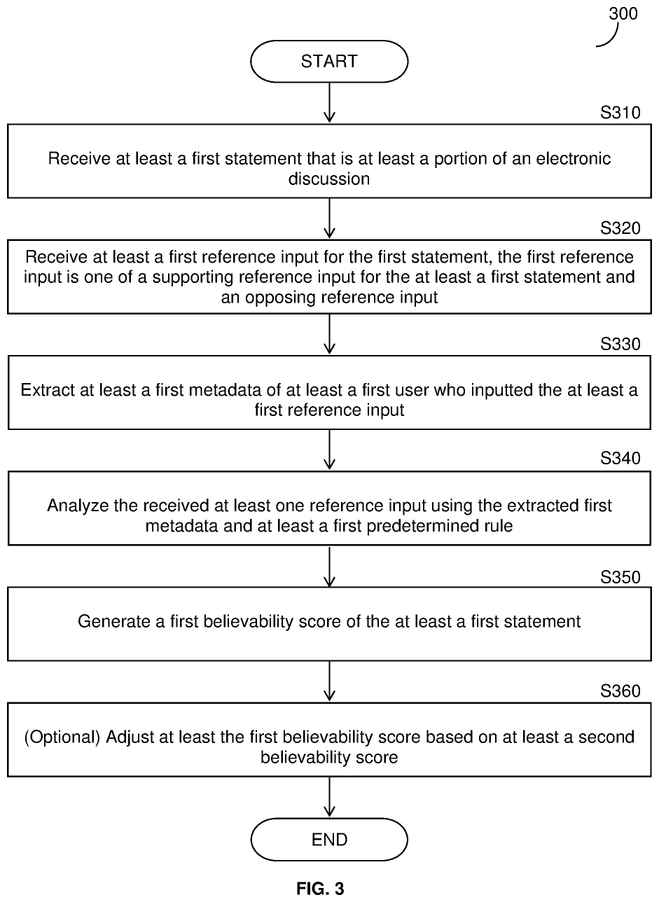

FIG. 3 is an example flowchart 300 illustrating a method for generating believability scores of statements in electronic discussions according to an embodiment. In an embodiment, the method may be performed by the computing device 120.

At S310, a first statement is received. The first statement is a portion of an electronic discussion. The statement may be an answer to a question, a reference input, such as a claim), a sub-reference input, such as a sub-claim, an image, a link, a video clip, etc. as further discussed hereinabove with respect of FIG. 1.

At S320, a first reference input for the first statement is received. The first reference input is at least one of a supporting reference input for the first statement and an opposing reference input for the first statement.

At S330, a first metadata of a first user who inputted the first reference input is extracted. The first metadata is at least one of a user believability score, a user topic-based believability score, and a relationship between the first user and a second user who inputted a second reference input of the electronic discussion, as further discussed herein above with respect to FIG. 1.

At S340, the received reference input is analyzed using the extracted first metadata and a first predetermined rule. The predetermined rule may be a mathematical rule, such as a formula, that, when analyzed together with the reference input and the extracted first metadata, facilitates the computing device 120 to determine a believability score of the first statement.

At S350, a first believability score of the first statement is generated based on the analysis.

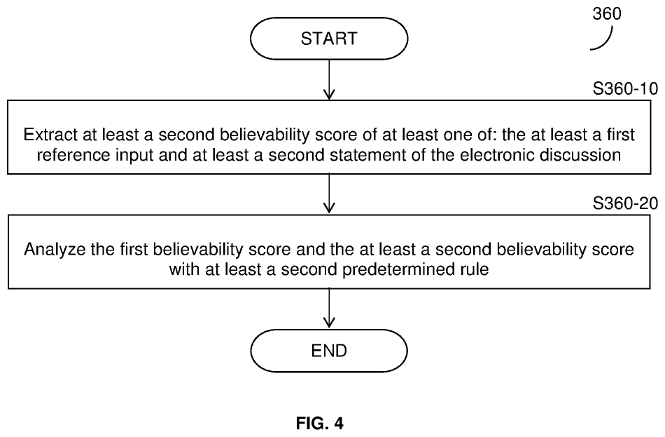

At the optional S360, the first believability score is adjusted based on a second believability score. The second believability score may be associated with at least one of a reference input and a second statement. It should be noted that the adjustment may be performed periodically when new related statements, reference inputs, or both, are received. In an embodiment, the second believability score may also be adjusted based on the first believability score. The adjustment described in S360 is further discussed in FIG. 4.

FIG. 4 is an example flowchart 360 that describes the process of adjusting a believability score of a statement according to an embodiment. Here, the first believability score of the first statement is adjusted based on a second believability score of the first reference input, a second statement of the electronic discussion, or both.

At S360-10, a second believability score is extracted. The second believability score is associated with at least one of the first reference input and a second statement of the electronic discussion. The second believability score may be extracted from a log file, database, data source, web source, and the like.

At S360-20, the first believability score and the second believability score are analyzed with respect to a second predetermined rule. The second predetermined rule may be a mathematic rule, such as a formula that computes the first believability score and the second believability score. An example of such a rule, as applied to the determination of a believability score, is discussed with respect to FIG. 6, below.

It should be noted that, based on the analysis, the first believability score and the second believability score may be adjusted. That is, as the electronic discussion develops, new reference inputs and new statements are received at the computing device 120, some of the inputs and statements have direct relations to the first statement and some may have indirect relations to the first statement. These new inputs and new statements, as well as their sub-reference inputs and sub-statements, may have influence on the first believability score. Also, a second believability score of a second statement, or of a reference input, may be adjusted as well, based on the new reference inputs and new statements. It should be noted that the analysis may be achieved using one or more machine learning algorithms.

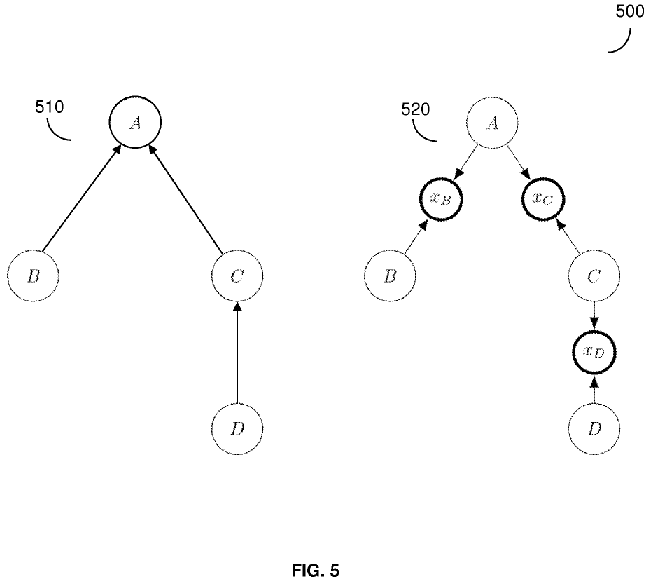

FIG. 5 is an example schematic array 500 diagram set illustrating the influence of reference inputs, such as votes, on a believability score of statements according to an embodiment. It should be noted that a statement may be also a reference input to which sub-reference inputs may refer. Diagram 510 shows a simple discussion tree with a statement, such as an answer, “A,” supported by reference input, such as a claim, “B,” and opposed by reference input “C,” which, in turn, is supported by another reference input, (such as a claim, “D.” Diagram 520 shows the corresponding Bayesian network representing the supporting and opposing relations with the observable nodes x_{K}∈{−1; +1}, where −1 and +1 represent opposing and supporting relations, respectively, whereas the claims themselves are represented by hidden nodes.

The process of accounting for votes in determining claim or sub-claim believability, as depicted according to diagram 520, includes the insertion of special claim or sub-claim nodes, representing the “claims” made by votes in support of, or opposition to, a given claim or sub-claim, into the hierarchical claim and sub-claim model. Where, as in the diagrams 510 and 520, claims and subclaims are represented in a hierarchical “node and link” tree diagram, wherein claims and sub-claims are represented as “nodes” and wherein relationships between claims and sub-claims are represented as “links,” votes may be incorporated into the same models by generation of “nodes” representing the believability of votes for a given claim or sub-claim.

Votes may be represented in “node and link” claim and sub-claim models as individual nodes, where the individual “vote nodes” may include, or may be pre-assigned, various believability scores, such as may be included or associated with “nodes” representing claims or sub-claims. The believability scores of votes supporting or opposing a given claim or sub-claim may be determined from the aggregation of believability scores of the individual votes cast in support of, or in opposition to, the given claim or sub-claim. The believability of a synthesized sub-claim, created to represent a given vote, may correspond with prior believability scores of the users casting individual votes, according to the following formula:

$$\tilde{p} = \frac{1 + {( \frac{1 + p}{1 - p} )}^{\frac{n ( v )}{v}}}{1 - {( \frac{1 + p}{1 - p} )}^{\frac{n ( v )}{v}}}$$

According to the above formula, the believability of a sub-claim “node” generated to represent the believability of a vote supporting a given claim or sub-claim, given as ‘\tilde{p},’ is equal to the quotient of a first quantity divided by a second quantity, where the first quantity is equal to one plus the quotient of one plus the voting user's prior claims' aggregate believability, ‘p,’ divided by one minus the voting user's prior claims' aggregate believability, ‘p,’ to the power of the quotient of the equivalent number of sub-claims, ‘n(v),’ for a given number of claims, ‘v,’ divided by the number of supporting votes, ‘v.’ The second, denominator quantity is equal to one minus plus the quotient of one plus the voting user's prior claims' aggregate believability, ‘p,’ divided by one minus the voting user's prior claims' aggregate believability, ‘p,’ to the power of the quotient of the equivalent number of sub-claims, ‘n(v),’ for a given number of supporting votes, ‘v,’ divided by the number of supporting votes, ‘v.’ The number of equivalent sub-claims, ‘n(v),’ for a given number of supporting votes, ‘v,’ is determined according to a pre-determined vote-weighting scheme, which may be configured to provide lower weightings for subsequent votes as the number of votes increases. In an embodiment, the number of equivalent sub-claims, ‘n(v),’ for a given number of supporting votes, ‘v,’ is given as the binary logarithm of the number of supporting votes, or log₂(v). While the formula above provides for the determination of a believability score for a sub-claim “node” generated to represent supporting votes for a given claim or sub-claim, it may be understood that the same principle may be equally applied to the determination of a believability score for a sub-claim “node” generated to represent opposing votes for a given claim or sub-claim by substituting the number of opposing votes for the number of supporting votes as the value of ‘v.’

In an embodiment, the disclosed method of believability scoring is based on a probabilistic graphical model. Specifically, a given discussion tree i.e., an answer, its related supporting and opposing reference inputs, such as claims, their respectively-related sub-reference inputs, such as sub-claims, and so on, is represented by a Bayesian network. The Bayesian network may include two types of nodes, where the first type refers to reference input, such as claim, nodes, hidden nodes that represent the state of a reference input, such as a claim, either being a correct reference input, which may, in an embodiment, be denoted as “true” or “1”, or an incorrect reference input which may, in an embodiment, be denoted as “false” or “0”.

These nodes are hidden because the true state of a reference input cannot be observed directly, but rather inferred from the structure and relations of the discussion, the available information on the users who claimed them, their content, and the like. The second type refers to relation nodes, observable nodes that correspond to the type of relation between two reference inputs, either supporting or opposing. These nodes represent the observed structure of the discussion tree.

FIG. 6 is an example flowchart 600 describing a method for assessing claim believability based on sub-claim believability, according to an embodiment.

At S610, one or more claims are collected. Claims may be statements purported to be facts describing a given topic, situation, or other subject. Claims may be collected from sources including, without limitation, the databases 130, user devices 140, and data sources 150, all of FIG. 1, above, as well as other, like, sources, and any combination thereof. An example of a claim may be a statement such as “this summer will be the hottest summer recorded for this city.”

At S620, one or more sub-claims are collected for the various claims collected at S610. Sub-claims may be statements relating to the respective claim or claims collected at S610, and may provide additional information supporting, opposing, or neither supporting or opposing the claims to which the various sub-claims relate. Sub-claims may be collected from those sources described with respect to S610, other, like, sources, or any combination thereof. An example of a supporting sub-claim may be, for the same example claim described in S610, a statement that “projections for this summer's weather in this city include an average high temperature greater than last year's average high temperature.” An example of an opposing sub-claim, related to the same example claim, may be a statement that “the neighboring city is projected to experience summer weather with lower average temperatures than last summer.” An example of a sub-claim neither supporting or opposing the same example claim, a “neutral subclaim,” may be a statement that “in this city, the temperature at night is generally lower than the temperature during the day.”

Sub-claims, as collected at S620, may be collected from the same body of text from which the respective claim is collected, such as an article, post, or message. Further, sub-claims may be collected from responses to the claim, such as reply comments on a forum post, responses in an email chain, replies in a message thread, and the like. Multiple sub-claims may be collected for a given claim. In an embodiment, sub-claims may relate to multiple claims and may be applicable to the determination of claim believability for all related claims. As an example, a forum thread may include two claims stating that “team A will beat team B in the playoffs,” and that “team B will beat team A in the playoffs.” A sub-claim may relate to each example claims where, for example, the sub-claim states that “team A has a stronger playoff record, but team B includes last year's league MVP.” In the example, the given sub-claim provides support for both the first and second example claims and may be, in combination with the factors hereinbelow, applicable to the determination of each claim's respective believability.

At the optional S630, sub-claim believability may be collected. Sub-claim believability describes the believability of the various sub-claims collected for a given claim. Sub-claim believability may include fractional, or otherwise standardized, believability ratings, describing the believability of a given sub-claim, for example, on a scale of zero to one. Sub-claim believability may be collected according to methods including, without limitation, application of the same or similar methods applied to the determination of claim believability as described in FIG. 6, collection only of sub-claims made by verified, certified, or otherwise pre-selected users or speakers, collection of sub-claims including one or more independently-verifiable statements, other, like, methods, and any combination thereof.

In an embodiment, where sub-claim believability scores cannot be collected, including due to a lack of relevant data, sub-claims may be considered approximately-equally-believable or equally-believable, and the believability of a given claim may be determined based on factors including the number of sub-claims supporting and opposing the respective claim. In the same embodiment, the aggregate believability of supporting sub-claims, cₛ, may be approximated as the sum of the believability scores of all supporting sub-claims, csi through csn, where T is an integer iterator value, which may be equal to one, and where ‘n’ is the number of sub-claims supporting the respective claim. Similarly, the aggregate believability of opposing sub-claims, cₒ, may be approximated as the sum of the believability scores of all supporting sub-claims, coi through con.

At S640, starting support is added for each claim. Starting support provides for the calculation of believability scores for claims which lack both supporting and opposing sub-claims by introducing a value to be applied in subsequent calculation of claim believability scores. Starting support may be provided on the premise that, at the time of creation, a given claim is self-supporting, indicating that a claim, in the absence of supporting or opposing sub-claims, is more believable than not. In an embodiment, a starting support value of six-hundred-eighteen thousandths, or 0.618, may be added.

At S650, claim feedback support is collected. Claim feedback support includes aggregate feedback providing non-sub-claim support or opposition for a given claim. Claim feedback support may be collected from “likes” and “dislikes,” “upvotes” and “downvotes,” and other non-statement indications of support or opposition, for a given claim. In an embodiment, claim feedback support may be applicable to the determination of claim believability, such as at S260. One or more claim feedback support scores may be determined according to the following formula:

$$v ( m ) = \{ \begin{matrix}0 , & m = 0 \\ \frac{1}{2} Φ , & m = 1 \\ Φ {log}_{2} m , & m \geq 2\end{matrix}$$

In the above formula, the influence factor, ‘v,’ of a number of claim feedback instances, such as “votes” on a post, the number given as ‘m,’ is determined according to a piecewise function, based on the number of claim feedback instances collected. Where the number of claim feedback instances is zero, the influence factor value for the same feedback instances is also zero. Where the number of claim feedback instances is one, the influence factor value is given as one-half of the starting support value, as determined at S640, where the starting support value is represented as ‘ϕ.’ Where the number of claim feedback instances is greater than or equal to two, the influence factor value is given as the product of the starting support value, ‘ϕ,’ multiplied by the binary logarithm, of the number of claim feedback instances, ‘m.’

At S660, claim believability is determined. Claim believability describes the believability of a given claim, based on supporting and opposing sub-claims, claim feedback instances, such as “likes” and “dislikes,” and one or more pre-determined starting support values. In the determination of a claim believability score at S660, support and opposition factors may be determined according to the following formulae:

bₛ=cₛ+ϕ*(1+v(mₛ))

bₒ=cₒ+ϕ*v(mₒ)

In the above equations, a support factor, ‘bₛ,’ is given as the sum of the aggregate supporting sub-claims' believability scores, as determined at S630 and given as ‘cₛ,’ added to the product of the starting support value, as defined at S640 and given as ‘ϕ,’ multiplied by the sum of one plus the feedback support score for all supporting feedback instances, determined as described with respect to S650 and given as ‘v(mₛ),’ where ‘mₛ’ is the number of feedback instances, such as “likes,” supporting the claim. Further, an opposition factor, bₒ, is given as the sum of the 2 aggregate opposing sub-claims' believability scores, as determined at S360 and given as ‘cₒ,” added to the product of the starting support value, as defined at S640 and given as ‘ϕ,’ multiplied by the feedback opposition score for all supporting feedback instances, determined as described with respect to S650 and given as ‘v(mₒ),’ where ‘mₒ’ is the number of feedback instances, such as “dislikes,” opposing the claim.

Based on the determined support and opposition factors, the believability of a given claim may be determined according to the following formula:

$$Believability = \frac{{b}_{s} + 1}{{b}_{s} + {b}_{o} + 2}$$

In the above equation, the believability of a given claim is determined as the quotient of the sum claim's support factor, ‘bₛ,’ added to one, divided by the sum of the claim's support factor, ‘bₛ,’ added to the claim's opposition factor, ‘bₒ,’ added to two.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating believability scores of statements in electronic discussions, comprising:
receiving a first statement, wherein the first statement is at least a portion of an electronic discussion;
receiving a first reference input for the first statement, wherein the first reference input is one of a supporting reference input for the first statement and an opposing reference input for the first statement;
extracting, from a log file, a first metadata of a first user associated with the first reference input;
analyzing the received first reference input using the extracted first metadata and at least a first predetermined rule; and
generating, based on the analysis, a first believability score of the first statement.

2. The method of claim 1, further comprising:
extracting a second believability score of at least one of: the first reference input and a second statement of the electronic discussion;
analyzing the first believability score and the second believability score with at least a second predetermined rule; and
adjusting at least one of the first believability score and the second believability score based on the result of the analysis.

3. The method of claim 2, further comprising:
performing display optimization of a plurality of statements and a plurality of reference inputs based on at least the first believability score and the second believability score.

4. The method of claim 2, wherein adjusting the first believability score and the second believability score, further comprises:
extracting the second believability score; and
analyzing the first believability score and the second believability score based on second predetermined rule.

5. The method of claim 4, further comprising:
continuously adjusting the first believability score and the second believability score as new inputs are received.

6. The method of claim 4, wherein the second believability score is associated with at least one of: the first reference input and the second statement of the electronic discussion.

7. The method of claim 1, wherein the first metadata is at least one of: a user believability score, a user topic-based believability score, and a relationship between the at least a first user and at least a second user providing a second reference input of the electronic discussion.

8. The method of claim 1, wherein the first reference input is a vote provided by the first user.

9. The method of claim 1, wherein the at least a first statement is at least one of: a textual statement, a visual statement, a link.

10. A non-transitory computer readable medium having stored thereon instructions for causing a processing circuitry to execute a process, the process comprising:
receiving a first statement, wherein the first statement is at least a portion of an electronic discussion;
receiving a first reference input for the first statement, wherein the first reference input is one of a supporting reference input for the first statement and an opposing reference input for the first statement;
extracting, from a log file, a first metadata of a first user associated with the first reference input;
analyzing the received first reference input using the extracted first metadata and at least a first predetermined rule; and
generating, based on the analysis, a first believability score of the first statement.

11. A system for generating believability scores of statements in electronic discussions, comprising:
a processing circuitry; and
a memory, the memory containing instructions that, when executed by the processing circuitry, configure the system to:
receive a first statement, wherein the first statement is at least a portion of an electronic discussion;
receive a first reference input for the first statement, wherein the first reference input is one of a supporting reference input for the first statement and an opposing reference input for the first statement;
extract, from a log file, a first metadata of a first user associated with the first reference input;
analyze the received first reference input using the extracted first metadata and at least a first predetermined rule; and
generate, based on the analysis, a first believability score of the first statement.

12. The system of claim 11, wherein the system is further configured to:
extract a second believability score of at least one of: the first reference input and a second statement of the electronic discussion;
analyze the first believability score and the second believability score with at least a second predetermined rule; and
adjust at least one of the first believability score and the second believability score based on the result of the analysis.

13. The system of claim 12, wherein the system is further configured to:
perform display optimization of a plurality of statements and a plurality of reference inputs based on at least the first believability score and the second believability score.

14. The system of claim 12, wherein the system is further configured to:
extract the second believability score; and
analyze the first believability score and the second believability score based on second predetermined rule.

15. The system of claim 14, wherein the system is further configured to:
continuously adjust the first believability score and the second believability score as new inputs are received.

16. The system of claim 14, wherein the second believability score is associated with at least one of: the first reference input and the second statement of the electronic discussion.

17. The system of claim 11, wherein the first metadata is at least one of: a user believability score, a user topic-based believability score, and a relationship between the at least a first user and at least a second user providing a second reference input of the electronic discussion.

18. The system of claim 11, wherein the first reference input is a vote provided by the first user.

19. The system of claim 11, wherein the at least a first statement is at least one of: a textual statement, a visual statement, a link.
